(19) United States
(12) Patent Application Publication
(10) Pub. No.: US 2014/0163934 A1
(43) Pub. Date: Jun. 12, 2014

(54) METHOD AND APPARATUS FOR DETERMINING AN AVERAGE WAIT TIME FOR USER ACTIVITIES BASED ON CONTEXTUAL SENSORS

(71) Applicant: PALO ALTO RESEARCH CENTER INCORPORATED, Palo Alto, CA (US)

(72) Inventors: Rui Zhang, San Francisco, CA (US); Oliver Brdiczka, Mountain View, CA (US); Kurt E. Partridge, Palo Alto, CA (US)

(73) Assignee: PALO ALTO RESEARCH CENTER INCORPORATED, Palo Alto, CA (US)

(21) Appl. No.: 13/707,493

(22) Filed: Dec. 6, 2012

(51) Int. Cl. G06F 17/50

(52) U.S. Cl. CPC G06F 17/5009
USPC 703/2

(57) ABSTRACT

A wait-queue modeling system facilitates computing a wait time for an activity type. During operation, the system obtains user-behavior events associated with one or more users waiting to perform an activity of a target activity type. The system can determine, based on the user-behavior events, activity-waiting attributes associated with users entering or leaving a waiting queue for an activity of the target activity type. The system then computes a wait time for the activity type based on the determined activity-waiting attributes.

### RELATED APPLICATION

The subject matter of this application is related to the subject matter in a co-pending non-provisional application by the same inventors as the instant application, entitled “SYSTEM AND METHOD FOR DETERMINING A DURATION FOR USER ACTIVITIES BASED ON SOCIAL-NETWORK EVENTS,” having Ser. No. 13/662,273, and filing date 26 Oct. 2012 (Attorney Docket No. PARC-20120447-US-NP).

### BACKGROUND

1. Field

This disclosure is generally related to modeling a user's behavior and activities. More specifically, this disclosure is related to determining a wait time for user activities based on behavior and location information that users share using social-media services.

2. Related Art

Advances in portable Internet-enabled computing technologies have made it easier for people to share and receive content while on the go. To take advantage of these portable computing capabilities and people's desire to share information, many entrepreneurs have produced online social-media services that allow people to share their social experiences with the general public in the form of micro-blogs or user-generated reviews. These social-media services also allow people to use their portable devices to search for recommendations for new places to visit or new activities to explore, and to share locations they've visited with others.

However, aside from all the benefits that these services provide to their members, these social-media services are finding it difficult to monetize on their large user base. One common revenue source is to provide paid advertisements or recommendations to users based on the activities they are performing. Some online services analyze a user's location and behavior to recommend an activity to the user, which oftentimes includes an activity that is popular among the user's demographic and/or is nearby to the user. Unfortunately, recommending a venue to the user based on its popularity can cause the user to travel to a crowded venue that may require the user to wait an undesirable amount of time before being serviced.

### SUMMARY

One embodiment provides a wait-queue modeling system that facilitates computing a wait time for an activity type. During operation, the system obtains user-behavior events associated with one or more users waiting to perform an activity of a target activity type. The system then determines activity-waiting attributes based on the user-behavior events, wherein a respective activity-waiting attribute indicates information associated with one or more users entering or leaving a waiting queue for an activity of the target activity type. The system then computes a wait time for the activity type based on the determined activity-waiting attributes.

In some embodiments, a user-behavior event includes location information for a user performing an activity of the activity type. Also, while determining the activity-waiting attributes, the system determines an arrival rate for the waiting queue for the activity type based on the check-in information, and determines a departure rate for the waiting queue for the activity type based on the check-in information.

In some embodiments, while computing the wait time, the system computes an arrival-departure ratio between the arrival rate and the departure rate, and computes an average waiting-queue-length based on the arrival-departure ratio. The system then computes an average wait time based on the arrival-departure ratio and the average waiting-queue-length.

In some embodiments, a user-behavior event includes a sensor measurement from a user's mobile computing device. Also, the sensor measurement can include one or more of: a gyroscope measurement; an accelerometer measurement; a compass measurement; a geographic-positioning measurement; and an audio reading.

In some embodiments, while determining the activity-waiting attributes, the system determines a wait-period start-time from the sensor measurements, and determines a wait-period end-time from the sensor measurements.

In some embodiments, while determining the wait-period start-time, the system detects a state change from an initial activity state to a waiting state. The system can detect the state change from the sensor measurements, such that the state change indicates that the user has entered the waiting queue.

In some embodiments, while determining the wait-period end-time, the system detects a state change from a waiting state to an activity state associated with the activity type. The system can detect the state change from the sensor measurements, such that the state change indicates that the user has left the waiting queue.

In some embodiments, while computing the wait time, the system computes a difference between the wait-period start-time and the wait-period end-time for the one or more users.

### BRIEF DESCRIPTION OF THE FIGURES

FIG. 1 illustrates an exemplary computer system that facilitates computing a wait time for an activity type in accordance with an embodiment.

FIG. 2 presents a flow chart illustrating a method for computing a wait-period for an activity of a target activity type in accordance with an embodiment.

FIG. 3 presents a flow chart illustrating a method for computing a wait-time based on location data and/or motion-sensor data in accordance with an embodiment.

FIG. 4 presents a flow chart illustrating a method for computing a wait-time based on an arrival-departure ratio in accordance with an embodiment.

FIG. 5 presents a flow chart illustrating a method for computing a wait-time based on a wait-period start-time and an end-time in accordance with an embodiment.

FIG. 6 illustrates an exemplary apparatus that facilitates computing a wait time for an activity type in accordance with an embodiment.

FIG. 7 illustrates an exemplary computer system that facilitates computing a wait time for an activity type in accordance with an embodiment.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention provide a wait-queue modeling system that solves the problem of estimating an amount of time that a person spends waiting to perform a certain activity or type of activity. The system can gather a combination of user-behavior events that describes a user's current location and/or behavior, and the system analyzes these user-behavior events to determine how much time the user or a group of users spends waiting in a queue to perform an activity.

In some embodiments, the system can gather user-behavior events, for one or more users, from social-media check-in services such as Facebook and Foursquare, as well as from location-sensor measurements and/or motion-sensor measurements provided by the user's mobile computing device. For example, some people may have a smartphone or phone service that routinely tracks their location (e.g., periodically at predetermined time intervals), and that makes their location trace available to a third-party service (e.g., an online social network or a location-based service). In exchange for sharing their location information, the third-party service can reward users with incentives (e.g., a coupon) to return to a favorite venue or to visit a new venue that may be of interest to the users. Further, some people may decide to configure their smartphone to periodically track their motion for use by one or more services, such as by the wait-queue modeling system, and possibly other applications such as health and fitness applications. The wait-queue analyzing system can analyze these location traces and motion-sensor measurements to compute an average wait time that a user (or a user demographic) spends waiting to perform a certain activity or type of activity.

Unfortunately, many users prefer to not have their location-enabled device track their motion and/or location, or they may prefer not to provide their real-time location trace to a third-party service. Some smartphone users may prefer not to have their smartphone use battery power for polling their location, while other users may prefer not to let others know their whereabouts and behavior at every moment for security reasons. In either case, these users may be selective as to when they decide to share their location and behavior information.

For example, users that visit a popular venue may indicate to others that they have visited the venue through one or more various techniques. Some users may decide to share their location information on a location-based service that provides incentives (e.g., Foursquare), or they may reveal their location on a user-review service (e.g., Yelp). Some users may post their location on an online social network for others to see (e.g., via Facebook, Twitter, Tumblr, etc.), or they may share their location via any other service now known or later developed.

In some embodiments, the wait-queue analyzing system can obtain behavior events for a plurality of users from these various sources. For example, a user may interact with the wait-queue analyzing system (e.g., via a mobile application or a web service) to determine a wait time for a certain activity. If the user is currently waiting to perform this activity, the system can obtain user-behavior events for the user, such as the user's location, and/or recent motion-sensor measurements from the user's mobile computing device.

As the system aggregates more user-behavior events from a plurality of users, the system can re-compute an expected wait time for an activity or type of activity to achieve more accurate results for a given time interval (e.g., for Monday afternoons). These user-behavior events can indicate a timestamp, a location (e.g., a geographic location or a location identifier) for the location event, and/or a sensor measurement (e.g., a measurement form an accelerometer or compass). The behavior event can also indicate a user identifier for the user performing the activity, a venue type for the location, an activity identifier or activity type for the activity that the user is waiting to perform, and/or any user-generated content (e.g., a picture, audio, video, a list of participants, and/or a text description of the activity).

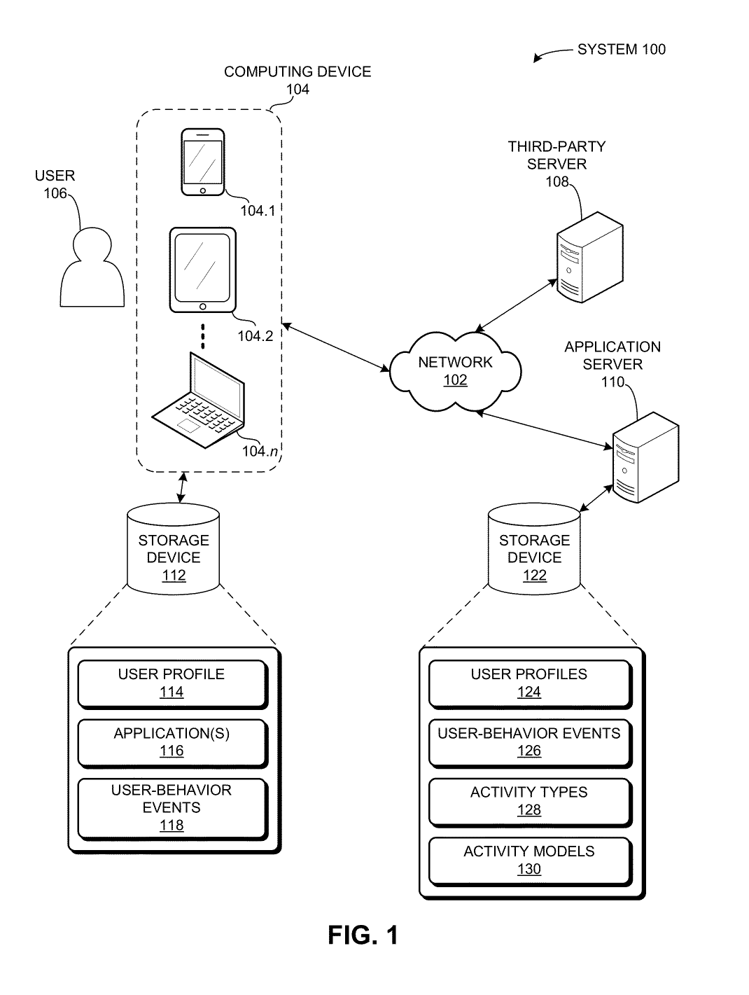

FIG. 1 illustrates an exemplary computer system 100 that facilitates computing a wait time for an activity type in accordance with an embodiment. Computer system 100 can include a computer network 102, which can include any wired or wireless network that interfaces various computing devices to each other, such as a computer network implemented via one or more technologies (e.g., Bluetooth, Wi-Fi, cellular, Ethernet, fiber-optic, etc.).

Computer system 100 can also include a computing device 104 coupled to network 102 and associated with a user 106, such as an portable computing device that user 106 can travel with, use to communicate with others, perform tasks, and manage a personal or shared calendar. For example, computing device 104 can include a smartphone 104.1, a tablet computer 104.2, or any other personal computing device 104.n such as a laptop computer, a desktop computer, etc.

As user 106 performs activities throughout the day, user 106 can use computing device 104 to share user-behavior events that include location-sensor and/or motion-sensor information related to the activities that user 106 is performing or waiting to perform. For example, user 106 can configure computing device 104 to periodically determine location and/or motion information about user 106 (e.g., using a location sensor embedded within or attached to computing device 104), and to upload this location and motion information to a third-party server 108 (e.g., a social-media service). The location-sensor measurements can include measurements made by a global positioning service (GPS) sensor, or a Wi-Fi or cell-tower triangulation device that can be used to track the user's location as well as a motion and direction over time. The motion-sensor measurements can include measurements made by an accelerometer and/or a compass of the user's mobile computing device that can be used to track fine-grained shifts in the user's motion and direction, such as while the user is standing in line or walking. Thus, third-party server 108 may store a location trace from one or more computing devices owned by one or more users (e.g., computing devices 104 owned by user 106), such that this location trace indicates a location for users as they perform activities throughout their day (e.g., travels to certain locations, meets with others, visits a restaurant or any other type of venue, etc.).

As another example, user 106 can manually interact with an application on computing device 104 (e.g., a Web browser or any other application executing on computing device 104) to provide a current location and/or behavior information to third-party server 108. Thus, user 106 may be selective as to which locations and activities he decides to share via third-party server 108. User 106 may share his location via a location-based service shortly after entering a venue (e.g., after being seated at a restaurant and before looking at the menu), and/or shortly before leaving the venue (e.g., to recommend the venue to friends or write a revue for the general public). In some embodiments, computing device 104 can gather additional contextual information associated with user 106 and the location. This additional contextual information can include information that identifies a venue at the sampled location (e.g., a store name, a business, a homeowner, etc.), identifies typical activities performed at the sampled location, identifies others close to user 106 (e.g., based on a Bluetooth or Wi-Fi signal detected from their mobile devices), etc.

During operation, an application server 110 can obtain user-behavior events (and any relevant contextual information), for user 106 and/or other users, from computing device 104 and/or third-party server 108. Application server 110 can analyze the gathered user-behavior events to identify activities performed by user 106, and to determine an activity wait time for each activity that user 106 has performed.

Application server 110 may also provide services to user 106. Application server 110 may automatically maintain a collection of scheduled activities for user 106 based on an expected wait time and/or activity-duration for these activities. For example, if user 106 is waiting to perform an activity that currently has a long wait time, application server 110 can reschedule other scheduled activities that user 106 may miss as a result of the long wait time. However, if user 106 leaves the venue without performing the activity (which device 104 or server 110 can detect by comparing the user's time spent at the venue with the expected wait time for the activity), application server 110 can add an entry into a calendar for user 106 to remind user 106 to perform the activity at a later date when the wait time is expected to be shorter.

Application server 110 may also recommend advertisements and/or incentives (e.g., coupons, gifts, etc.) for user 106 based on an expected wait time for his current or scheduled activity, such as to provide the advertisement and/or incentive for the user to visit a competing venue that does not require as long of a wait.

In some embodiments, computing device 104 can include or be coupled to a storage device 112, which can store a use profile 114 for user 106, application(s) 116, and user-behavior events 118. User profile 114 can include user-account information, address and contact information, as well as demographic information for user 106. Specifically, the user-account information may indicate user accounts for one or more social-media services (e.g., a service hosted by third-party server 108), which can be used by applications 116 and/or application server 110 to access third-party server 108 to obtain user-behavior events associated with user 106.

The user-account information may also include tokens that can be used to allow an application 116 or application server 110 to access a social-media service on third-party server 108 without requiring user 106 to provide a password. For example, user 106 may use an account name and password to authenticate computing device 104 or application server 110 using an open-authorization protocol, which provides an authorization token to computing device 104 or application server 110. This authorization token grants application 116 or application server 110 access to some or all features from a user-account associated with user 106 (e.g., pictures, “friends,” visited locations, articles read, and/or any other user-behavior information). Applications 116 and/or application server 110 can use this authorization token to access third-party server 108 to obtain user-behavior events associated with user 106.

Further, Applications 116 can generate user-behavior events 118 pertaining to user 106 either periodically or in response to a request from user 106, and can upload user-behavior events 118 to third-party server 108. If an application is periodically polling a motion and/or location for user 106, computing device 104 can generate user-behavior events 118 to include a complete motion and/or location trace for user 106. In some embodiments, computing device 104 can reduce a number of user-behavior events that are stored for user 106, for example, by only recording a user-behavior event when user 106 moves at least a threshold distance (e.g., 5 meters) from a recently recorded location event, or when the user's behavior changes state (e.g., changes from walking to waiting, or changes from waiting to walking).

TABLE 2

65905786|2011-01-24 06:59:13|1295881153|2011-01-24 13:59:13|324199|-
6.5617541|106.7318938|IPB Dramaga|105|College & Education:University
65917051|2011-01-24 07:55:46|1295884546|2011-01-24 14:55:46|324199|-
6.5617541|106.7318938|IPB Dramaga|105|College & Education:University
65917494|2011-01-24 07:57:54|1295884674|2011-01-24 14:57:54|324199|-
6.5617541|106.7318938|IPB Dramaga|105|College & Education:University
65920601|2011-01-24 08:13:05|1295885585|2011-01-24 15:13:05|324199|-
6.5617541|106.7318938|IPB Dramaga|105|College & Education:University
65928585|2011-01-24 08:57:30|1295888250|2011-01-24 15:57:30|324199|-
6.5617541|106.7318938|IPB Dramaga|105|College & Education:University
65929089|2011-01-24 09:00:10|1295888410|2011-01-24 16:00:10|324199|-
6.5617541|106.7318938|IPB Dramaga|105|College & Education:University

As another example, computing device 104 can perform geo-fencing to store only user-behavior events 118 for when user 106 moves near a border of a geo-location fence (e.g., a border for a geographic region that has been assigned to an activity or an activity type). Table 2 presents an exemplary sequence of periodic location events that have been filtered using geo-fencing in accordance with an embodiment.

In some embodiments, application server 110 can include or be coupled to a storage device 122, which can store use profiles 124 for a plurality of users 124, user-behavior events 126 for the plurality of users, a pre-defined or user-defined collection of activity types 128, and activity models 130 for a plurality of various activities or activity types. During operation, application server 110 can obtain user-behavior events 126 associated with a plurality of users (e.g., via third-party server 108), and can generate activity models 130 for activity types 128 based on user profiles 124 and user-behavior events 126. Application server 110 can generate some activity models so that they are specific to an individual user, for example, by generating the activity model based on this user's past activity. Application server 110 can also generate some activity models so that they can predict an amount of time that a user is likely to spend waiting to perform an activity based on behavior information from a group of similar individuals (e.g., a group of users that have substantially similar profile attributes).

### Wait-Queue Modeling System

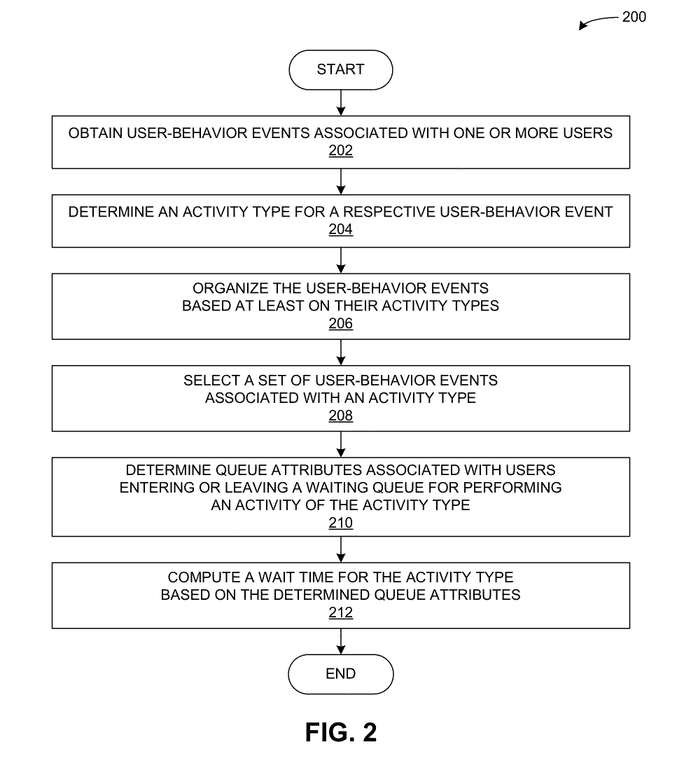

FIG. 2 presents a flow chart illustrating a method 200 for computing a wait-period for an activity of a target activity type in accordance with an embodiment. During operation, the system can obtain user-behavior events associated with one or more users (operation 202). The system determines an activity type for a respective user-behavior event (operation 204), and organizes the user-behavior events based at least on their activity types (operation 206). By organizing the user-behavior events, the system can easily group user-behavior events from a plurality of users that have performed a common activity, which allows the system to compute a wait time that has a higher accuracy than if only one user's events were used.

The system then selects a set of user-behavior events associated with an activity type (operation 208), and determines activity-waiting attributes associated with users entering or leaving the queue for performing an activity of the activity type (operation 210). In some embodiments, the activity-waiting attributes can include a wait-period start time and a wait-period start time. In some other embodiments, the activity-waiting attributes can include an arrival rate and a departure rate for the waiting queue, and an arrival-departure ratio between the arrival rate and the departure rate. The system then computes a wait time for the activity type based on the determined activity-waiting attributes (operation 212).

In some embodiments, the system can compute a wait time using historical user-behavior events that were obtained for one or more users by partitioning the user-behavior events into analysis intervals of T minutes, and analyzing the individual analysis intervals. An analysis interval Tᵢ can include any point in time that satisfies a temporal granularity and/or a contextual constraint. The temporal granularity can specify one or more of: a time of day; day of the week; day of the month; day of the year; month of the year, etc. The contextual constraint can indicate environmental factors, such as a weather condition, other participants of the activity (e.g., news reporters interviewing people waiting in line to enter an electronics store), a related news-generating event (e.g., reports of a new electronic device being released), etc.

The system can select the temporal granularity and/or the contextual constraints, on a case-by-case basis, based on which activity the user is waiting to perform. For example, to determine a wait time for being seated at a diner, the temporal granularity can specify a time of day range from 10 AM to 10 PM, and a day of the week range that includes a full calendar week (Sunday to Saturday), partitioned into 15-minute intervals. Thus, when selecting an analysis interval, the system can span a calendar week, selecting 15-minute time intervals between the hours of 10 AM and 10 PM from any week of any year. As another example, to determine a wait time for being seated at a popular restaurant, the temporal granularity can specify that the user-behavior events be partitioned into 60-minute intervals.

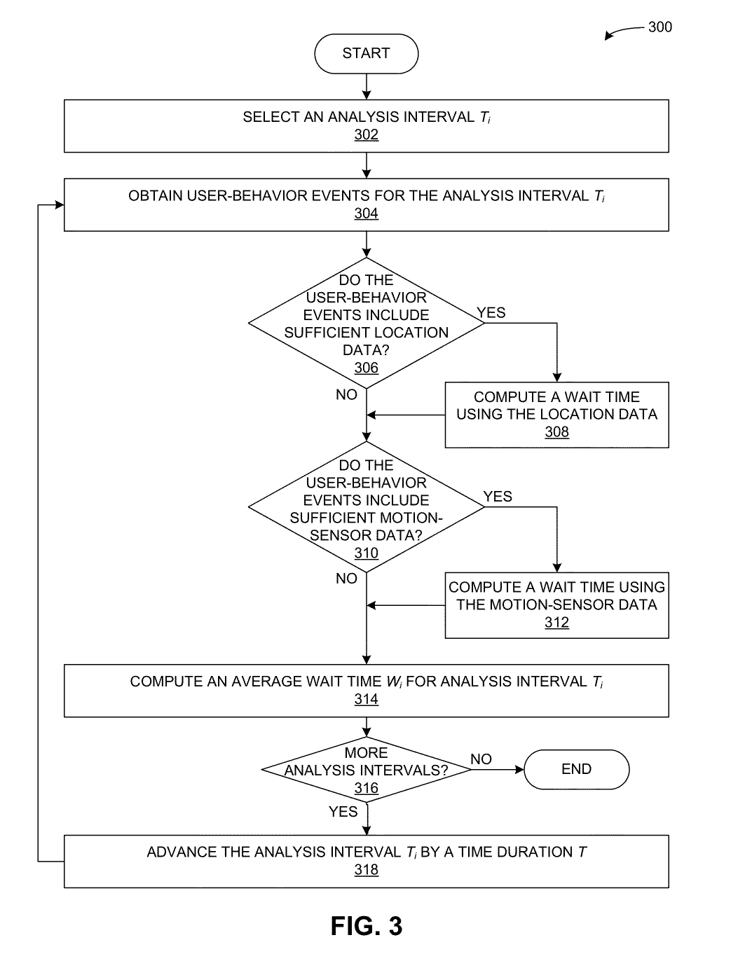

FIG. 3 presents a flow chart illustrating a method 300 for computing a wait-time based on location data and/or motion-sensor data in accordance with an embodiment. During operation, the system selects an analysis interval Tᵢ based on a predetermined temporal granularity (operation 302), and obtains user-behavior events for the analysis interval Tᵢ (operation 304). The system then determines whether the user-behavior events include sufficient location data (operation 306). If so, the system can compute a wait time for the analysis interval Tᵢ using the location data (operation 308). For example, a user that has configured his smartphone (or any other mobile device) to poll the user's location periodically or during key events (e.g., when the user's location changes by a threshold amount, to provide the user's location to a location check-in service) can provide sufficient location data for computing a wait time. On the other hand, a user that manually checks-in his location into the location check-in service may not be able to provide sufficient location data for computing a wait time.

The system also determines whether the user-behavior events include sufficient motion-sensor data (operation 310). The motion-sensor data can include, for example, a gyroscope measurement, an accelerometer measurement, and/or a compass measurement. If the user-behavior events include sufficient motion-sensor data, the system computes a wait time for the analysis interval Tᵢ using the sensor data (operation 312). For example, the user-behavior events may include a sufficient amount of motion-sensor data if the user's device includes an accelerometer and the user was moving (e.g., walking) during analysis interval Ti. On the other hand, the user-behavior events may not include a sufficient amount of motion-sensor data if the user's device does not include an accelerometer or any other motion sensor, and/or if the user is currently standing still or sitting down (e.g., in a waiting room) while waiting to perform an activity (e.g., visit a dentist).

The system then computes an average wait time Wᵢ for the analysis interval Tᵢ (operation 314) based on wait times computed using the location data and/or the motion-sensor data. For example, the system can compute the average wait time Wi as follows:

$${!}_{!} = \frac{\vert {!}_{! , !} \vert * {!}_{! , !} ! \vert {!}_{! , !} \vert * {!}_{! , !}}{\vert {!}_{! , !} \vert !! \vert {!}_{!} \vert} \qquad ( 1 )$$

In (1), |^{!}l,l indicates a number of user-behavior events that include location data for analysis interval i, and ^{!}l,l indicates a wait time computed for analysis interval i using the location data. Also, |^{!}l,l indicates a number of user-behavior events that include motion-sensor data for analysis interval i, and ^{!}l,l indicates a wait time computed for analysis interval i using the motion-sensor data.

In some embodiments, if the system determines that the user-behavior events do not provide sufficient location or motion-sensor data, the system can perform a remedial action. For example, the system can compute a wait time for the activity for the analysis interval Tᵢ by computing an average of other time proximal analysis intervals (e.g., other time intervals within a threshold distance across one or more dimensions of a time-of-day, a day-of-week, a day-of-month, a day-of-year, etc.). As another example, the system can assign an empty or a zero value as the wait time for the analysis interval Tᵢ.

The system then determines whether there are more analysis intervals to analyze (operation 316). If so, the system advances the analysis interval Tᵢ by a time duration T (operation 318), and returns to operation 302 to obtain additional user-behavior events for the user. The system advance the analysis interval Tᵢ by selecting a subsequent analysis interval of time duration T based on the predetermined temporal granularity and/or contextual constraints.

In some embodiments, some users that have performed an activity in the past may provide a location trace that explicitly indicates when they have entered and left a waiting queue to perform the activity. The system can use this collection of user-behavior events to compute the wait time based on time instances at which one or more users have entered and left the waiting queue.

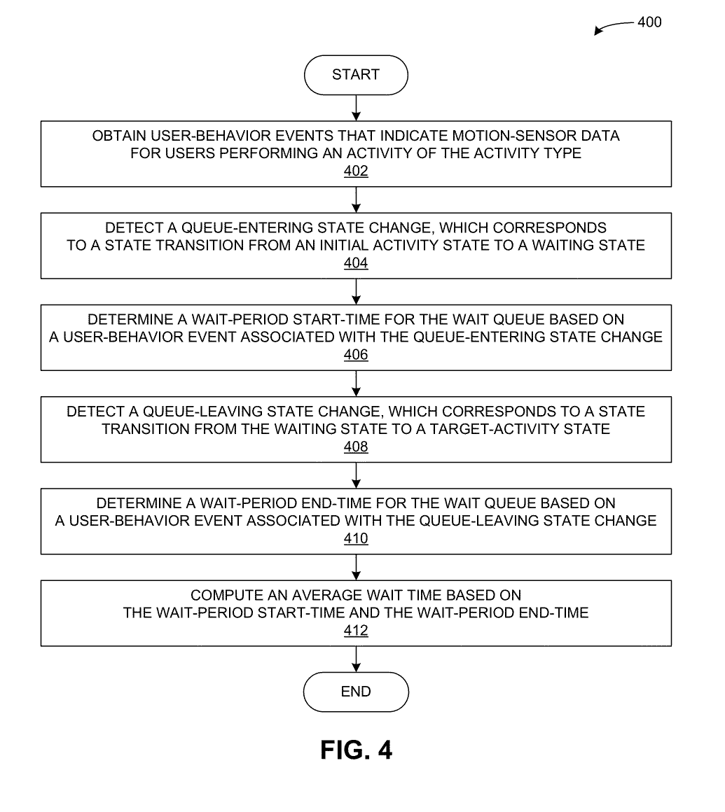

FIG. 4 presents a flow chart illustrating a method 500 for computing a wait-time based on a wait-period start-time and an end-time in accordance with an embodiment. During operation, the system obtains user-behavior events that indicate motion-sensor data for users performing an activity of the activity type (operation 402). Then, the system detects a queue-entering state change from the user-behavior events (operation 404). The queue-entering state change corresponds to a state transition from an initial activity to a waiting state. For example, users oftentimes walk for at least a small amount of time prior to waiting to perform an activity, such as from a parking lot to a venue associated with the target activity. The system can monitor one or more sensors on the user's mobile computing device to detect a change in state in the user's behavior or environment that indicates the user has likely entered a waiting queue, such as by detecting an event at which the user stopped walking, and began waiting to perform an activity.

For example, the system use a GPS sensor and an accelerometer trace to detect when the user is driving, which could indicate that the user is traveling to perform an activity. Once the user parks his car and the user walks to a venue, such as a restaurant, the system can detect a change in state in the user's behavior to a walking state based on a walking motion detected from the accelerometer's repetitive motion in a vertical direction, in combination with a slow but steady motion in a horizontal direction as determined by the GPS sensor. The system can determine that, because the user is walking, the user is likely in close proximity to a venue associated with the user's next target activity.

Then, if the system determines that the user's behavior has transitioned from a walking state to a state that involves minimal change in GPS coordinates in combination with subtle variations in the accelerometer's trace (e.g., due to the user's change in pose), the system can determine that the user has transitioned into a waiting state. In some embodiments, the system can also determine that the user is waiting to perform an activity based on other environmental factors, such as by sounds detected by a microphone on the mobile computing device.

The system then determines a wait-period start time for the wait queue based on a user-behavior event associated with the queue-entering state change (operation 406). In some embodiments, the system can detect the wait-period start-time by recording a timestamp for a signal associated with the queue-entering state change as the wait-period start-time.

The system also detects a queue-leaving state change, which corresponds to a state transition from the waiting state to a target-activity state (operation 408). For example, users oftentimes stand while waiting to perform an activity, during which time they may make small movements such as to shift their pose. The system can determine a user-behavior event at which the user stopped waiting to perform an activity, and began performing the activity. For example, the system can monitor one or more sensors on the user's mobile computing device to detect a change in state in the user's behavior or environment that indicates the user has likely left the waiting queue.

For example, the system can detect when the user's behavior transitions back into a walking state. If the user remains at a walking state for more than a threshold period of time, the use is likely leaving a venue associated with the intended activity. However, if the user enters the walking state for a short period of time (e.g., for less than the threshold period of time), followed by another transition into another stationary state, it is likely the user has walked away from the waiting queue and is now at a location within the venue associated with the target activity (e.g., at a restaurant table). In some embodiments, the system can also determine that the user is no longer waiting to perform the activity based on other environmental factors as determined by a microphone, a wireless communication module, and/or any other devices on the user's mobile computing device. These detected environmental factors can include a change in ambient sounds as detected by a microphone, or a change in the user's neighboring devices as detected by a wireless communication module (e.g., identifying signals from other Wi-Fi and/or Bluetooth devices).

The system then determines a wait-period end time for the wait queue based on a user-behavior event associated with the queue-leaving state change (operation 410). In some embodiments, the system can detect the wait-period end-time by recording a timestamp for a signal associated with the queue-leaving state change as the wait-period end-time. The system then computes an average wait time by computing an average of the wait-period start-time and the wait-period end-time (operation 412).

In some embodiments, it is often the case that the users which have performed an activity in the past have not provided a location trace that explicitly indicates when they have entered and left a waiting queue to perform the activity. However, the system may have obtained user-behavior events from a sufficient number of individuals to amass a significant number of user-behavior events. The system can use this collection of user-behavior events to compute a ratio between the rate at which people enter and leave the waiting queue. The system can use this arrival-departure ratio to compute an average length for the waiting queue, as well as an average wait time for the waiting queue.

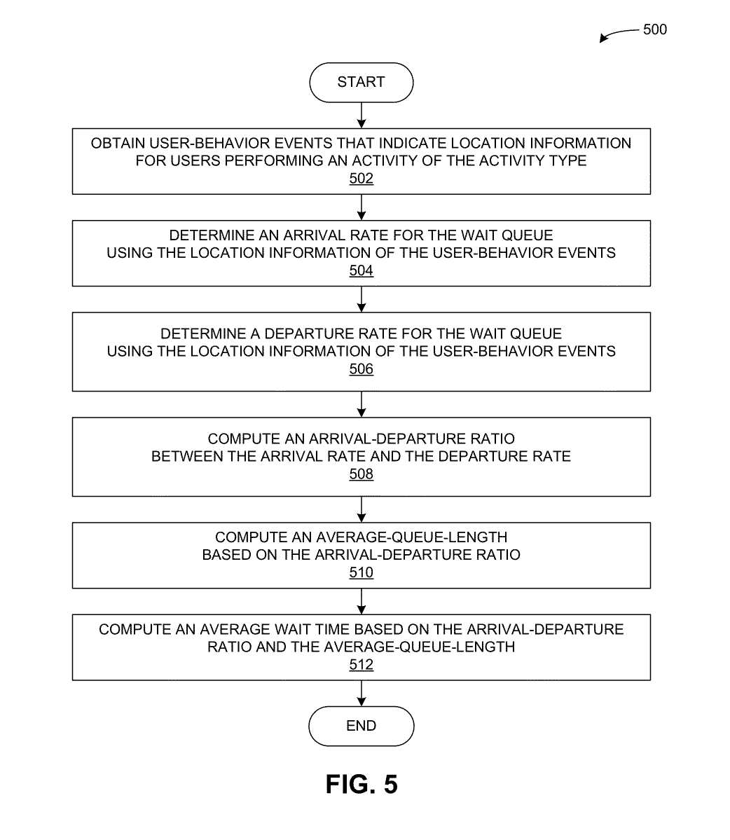

FIG. 5 presents a flow chart illustrating a method 500 for computing a wait-time based on an arrival-departure ratio in accordance with an embodiment. During operation, the system can obtain user-behavior events that indicate location information for users performing an activity of the activity type (operation 502). The system can use the location information of these user-behavior events to determine an arrival rate for the wait queue (operation 504), and to determine a departure rate for the wait queue (operation 506).

In some embodiments, the system can determine the arrival rate by counting a number of check-in events for an activity or type of activity during a predetermined analysis time interval (e.g., via an online location-based service), or by using the check-in events to estimate a number of people that have started performing the activity during the analysis time interval. Also, the system can determine the departure rate by counting a number of check-out events for the activity, or by using the check-out events to estimate a number of people that have stopped performing the activity during the analysis time interval.

The system then computes an arrival-departure ratio between the arrival rate and the departure rate (operation 508), and computes an average waiting-queue-length based on the arrival departure rate (operation 510). In some embodiments, the system can compute the arrival-departure ratio by computing:

$$!= \frac{!}{!} \qquad ( 2 )$$

In equation (2), λ indicates the arrival rate, μ indicates the departure rate, and ρ indicates the arrival-departure ratio.

To compute the average waiting-queue-length, the system computes the probability of the queue being empty P₀:

$${P}_{0} = \frac{1}{{\sum }_{{n}_{c} = 0}^{N - 1} \frac{{ρ}^{{n}_{c}}}{{n}_{c} !} + \frac{{ρ}^{N}}{N ! ( 1 - ρ \text{/} N )}} \qquad ( 3 )$$

In equation (3), N indicates a number of servers available for the activity (e.g., a number of tables in a restaurant, a number of seats on a roller coaster ride, etc.). Then the system computes the average waiting-queue-length, Q̅, using:

$$\overline{Q} = \frac{{P}_{0} {ρ}^{N + 1}}{N ! N} [ \frac{1}{{( 1 - ρ \text{/} N )}^{2}} ] \qquad ( 4 )$$

The system then computes an average wait time based on the arrival-departure ratio and the average waiting-queue-length (operation 512). For example, the system can compute the average wait time by computing:

$$\overline{w} = \frac{ρ + \overline{Q}}{λ} - \frac{1}{μ} \qquad ( 5 )$$

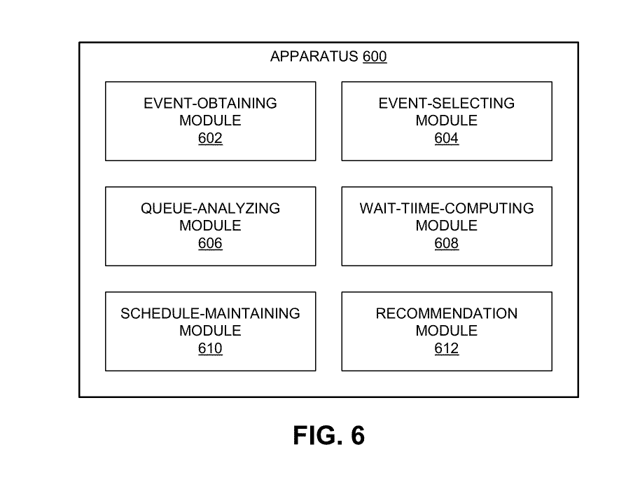

FIG. 6 illustrates an exemplary apparatus 600 that facilitates computing a wait time for an activity in accordance with an embodiment. Apparatus 600 can comprise a plurality of modules which may communicate with one another via a wired or wireless communication channel. Apparatus 600 may be realized using one or more integrated circuits, and may include fewer or more modules than those shown in FIG. 6. Further, apparatus 600 may be integrated in a computer system, or realized as a separate device which is capable of communicating with other computer systems and/or devices. Specifically, apparatus 600 can comprise an event-obtaining module 602, an event-selecting module 604, a queue-analyzing module 606, a wait-time computing module 608, a schedule-maintaining module 610, and a recommendation module 612.

In some embodiments, event-obtaining module 602 can obtain user-behavior events associated with one or more users waiting to perform an activity of a target activity type. Event-selecting module 604 can select, from the obtained events, one or more events to use for computing a wait time. Queue-analyzing module 606 can determine, based on the user-behavior events, activity-waiting attributes associated with users entering or leaving a waiting queue for an activity of the target activity type. Wait-time computing module 608 can compute a wait time for the activity type based on the determined activity-waiting attributes.

Schedule-maintaining module 610 can update a user's schedule based on an expected wait time for an activity in the user's schedule. Recommendation module 612 can recommend an activity to the user based on a wait time for the user's current activity, and/or based on a wait time for the activity being recommended to the user.

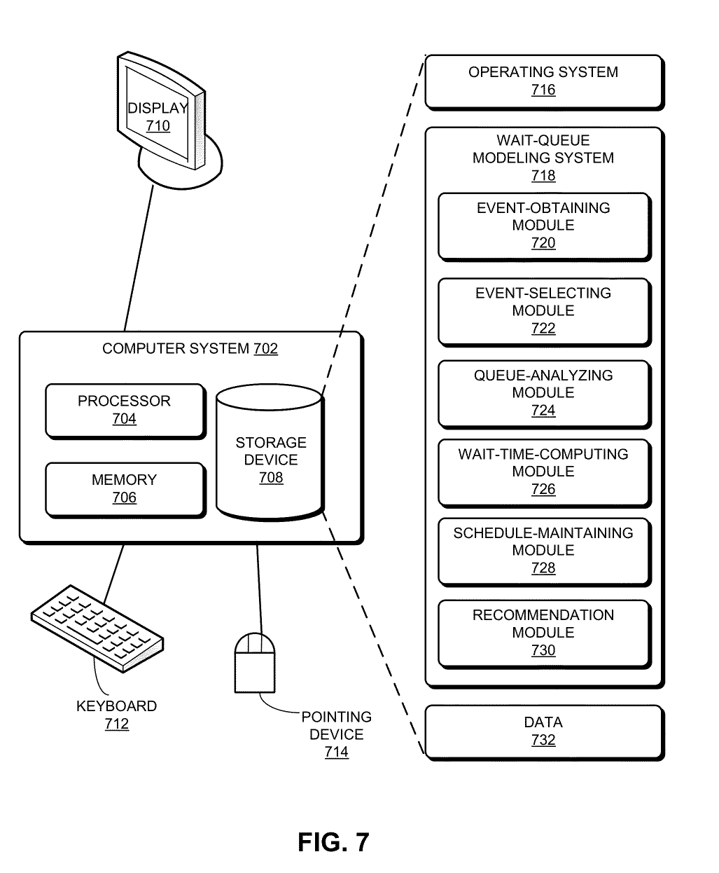

FIG. 7 illustrates an exemplary computer system 702 that facilitates computing a wait time for an activity in accordance with an embodiment. Computer system 702 includes a processor 704, a memory 706, and a storage device 708. Memory 706 can include a volatile memory (e.g., RAM) that serves as a managed memory, and can be used to store one or more memory pools. Furthermore, computer system 702 can be coupled to a display device 710, a keyboard 712, and a pointing device 714. Storage device 708 can store operating system 716, wait-queue modeling system 718, and data 732.

Wait-queue modeling system 718 can include instructions, which when executed by computer system 702, can cause computer system 702 to perform methods and/or processes described in this disclosure. Specifically, wait-queue modeling system 718 may include instructions for obtaining user-behavior events associated with one or more users waiting to perform an activity of a target activity type (event-obtaining module 720), and instructions for selecting one or more events to use for computing a wait time (event-selecting module 722). Further, wait-queue modeling system 718 can include instructions for determining, based on the user-behavior events, activity-waiting attributes associated with users entering or leaving a waiting queue for an activity of the target activity type (queue-analyzing module 724). Wait-queue modeling system 718 can also include instructions for computing a wait time for the activity type based on the determined activity-waiting attributes (wait-time computing module 726).

Wait-queue modeling system 718 can include instructions for updating a user's schedule based on an expected wait time for an activity in the user's schedule (schedule-maintaining module 728). Wait-queue modeling system 718 can also include instructions for recommending an activity to the user based on a wait time for the user's current activity, and/or based on a wait time for the activity being recommended to the user (recommendation module 730).

Data 732 can include any data that is required as input or that is generated as output by the methods and/or processes described in this disclosure. Specifically, data 732 can store at least user events, activity-waiting attributes, and wait times for one or more activities.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described above can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A computer-implemented method, comprising:
obtaining user-behavior events associated with one or more users waiting to perform an activity of a target activity type;
determining activity-waiting attributes based on the user-behavior events, wherein a respective activity-waiting attribute indicates information associated with one or more users entering or leaving a waiting queue for an activity of the target activity type; and
computing a wait time for the activity type based on the determined activity-waiting attributes.

2. The method of claim 1, wherein a user-behavior event includes location information for a user performing an activity of the activity type; and
wherein determining the activity-waiting attributes involves:
determining an arrival rate for the waiting queue for the activity type based on the check-in information; and
determining a departure rate for the waiting queue for the activity type based on the check-in information.

3. The method of claim 2, wherein computing the wait time involves:
computing an arrival-departure ratio between the arrival rate and the departure rate;
computing an average waiting-queue-length based on the arrival-departure ratio; and
computing an average wait time based on the arrival-departure ratio and the average waiting-queue-length.

4. The method of claim 1, wherein a user-behavior event includes a sensor measurement from a user's mobile computing device, and wherein determining the activity-waiting attributes involves:
determining a wait-period start-time from the sensor measurements; and
determining a wait-period end-time from the sensor measurements.

5. The method of claim 4, wherein the sensor measurement includes one or more of:
a gyroscope measurement;
an accelerometer measurement;
a compass measurement;
a geographic-positioning measurement; and
an audio reading.

6. The method of claim 4, wherein determining the wait-period start-time involves:
detecting, from the sensor measurements, a state change from an initial activity state to a waiting state, wherein the state change indicates that the user has entered the waiting queue.

7. The method of claim 4, wherein determining the wait-period end-time involves:
detecting, from the sensor measurements, a state change from a waiting state to an activity state associated with the activity type, wherein the state change indicates that the user has left the waiting queue.

8. The method of claim 4, wherein computing the wait time involves:
computing a difference between the wait-period start-time and the wait-period end-time for the one or more users.

9. A non-transitory computer-readable storage medium storing instructions that when executed by a computer cause the computer to perform a method, the method comprising:
obtaining user-behavior events associated with one or more users waiting to perform an activity of a target activity type;
determining activity-waiting attributes based on the user-behavior events, wherein a respective activity-waiting attribute indicates information associated with one or more users entering or leaving a waiting queue for an activity of the target activity type; and
computing a wait time for the activity type based on the determined activity-waiting attributes.

10. The storage medium of claim 9, wherein a user-behavior event includes location information for a user performing an activity of the activity type; and
wherein determining the activity-waiting attributes involves:
determining an arrival rate for the waiting queue for the activity type based on the check-in information; and
determining a departure rate for the waiting queue for the activity type based on the check-in information.

11. The storage medium of claim 10, wherein computing the wait time involves:
computing an arrival-departure ratio between the arrival rate and the departure rate;
computing an average waiting-queue-length based on the arrival-departure ratio; and
computing an average wait time based on the arrival-departure ratio and the average waiting-queue-length.

12. The storage medium of claim 9, wherein a user-behavior event includes a sensor measurement from a user's mobile computing device, and wherein determining the activity-waiting attributes involves:
determining a wait-period start-time from the sensor measurements; and
determining a wait-period end-time from the sensor measurements.

13. The storage medium of claim 12, wherein the sensor measurement includes one or more of:
a gyroscope measurement;
an accelerometer measurement;
a compass measurement;
a geographic-positioning measurement; and
an audio reading.

14. The storage medium of claim 12, wherein determining the wait-period start-time involves:
detecting, from the sensor measurements, a state change from an initial activity state to a waiting state, wherein the state change indicates that the user has entered the waiting queue.

15. The storage medium of claim 12, wherein determining the wait-period end-time involves:
detecting, from the sensor measurements, a state change from a waiting state to an activity state associated with the activity type, wherein the state change indicates that the user has left the waiting queue.

16. The storage medium of claim 12, wherein computing the wait time involves:
computing a difference between the wait-period start-time and the wait-period end-time for the one or more users.

17. An apparatus, comprising:
an event-obtaining module to obtain user-behavior events associated with one or more users waiting to perform an activity of a target activity type;
a queue-analyzing module to determine activity-waiting attributes based on the user-behavior events, wherein a respective activity-waiting attributes indicates information associated with one or more users entering or leaving a waiting queue for an activity of the target activity type; and
a wait-time-computing module to compute a wait time for the activity type based on the determined activity-waiting attributes.

18. The apparatus of claim 17, wherein a user-behavior event includes location information for a user performing an activity of the activity type; and
wherein while determining the activity-waiting attributes, the queue-analyzing module is further configured to:
determine an arrival rate for the waiting queue for the activity type based on the check-in information; and
determine a departure rate for the waiting queue for the activity type based on the check-in information.

19. The apparatus of claim 18, wherein while computing the wait time, the wait-time-computing module is further configured to:
compute an arrival-departure ratio between the arrival rate and the departure rate;
compute an average waiting-queue-length based on the arrival-departure ratio; and
compute an average wait time based on the arrival-departure ratio and the average waiting-queue-length.

20. The apparatus of claim 17, wherein a user-behavior event includes a sensor measurement from a user's mobile computing device, and wherein while determining the activity-waiting attributes, the queue-analyzing module is further configured to:
determine a wait-period start-time from the sensor measurements; and
determine a wait-period end-time from the sensor measurements.

21. The apparatus of claim 20, wherein the sensor measurement includes one or more of:
a gyroscope measurement;
an accelerometer measurement;
a compass measurement;
a geographic-positioning measurement; and
an audio reading.

22. The apparatus of claim 20, wherein while determining the wait-period start-time, the queue-analyzing module is further configured to:
detect, from the sensor measurements, a state change from an initial activity state to a waiting state, wherein the state change indicates that the user has entered the waiting queue.

23. The apparatus of claim 20, wherein while determining the wait-period end-time, the queue-analyzing module is further configured to:
detect, from the sensor measurements, a state change from a waiting state to an activity state associated with the activity type, wherein the state change indicates that the user has left the waiting queue.

24. The apparatus of claim 20, wherein while computing the wait time, the wait-time-computing module is further configured to:
compute a difference between the wait-period start-time and the wait-period end-time for the one or more users.
